(19) United States
(12) Patent Application Publication
(10) Pub. No.: US 2026/0270900 A1
(43) Pub. Date: Sep. 10, 2026

(54) COMMUNICATION APPARATUS AND CONTROL METHOD

(71) Applicant: KABUSHIKI KAISHA TOSHIBA, Kawasaki-shi (JP)

(72) Inventors: Toshihiro TANGO, Fuchu Tokyo (JP); Toshinori DOI, Tokyo (JP)

(73) Assignee: KABUSHIKI KAISHA TOSHIBA, Kawasaki-shi (JP)

(21) Appl. No.: 19/661,886

(22) Filed: Apr. 29, 2026

Related U.S. Application Data
(63) Continuation of application No. PCT/JP2024/038744, filed on Oct. 30, 2024.

(30) Foreign Application Priority Data
Nov. 1, 2023 (JP) 2023-187872

(51) Int. Cl. H04W 56/00; H04L 27/26; H04W 52/32

(52) U.S. Cl. CPC H04W 56/001; H04L 27/265; H04W 52/325

(57) ABSTRACT

According to one embodiment, a communication apparatus in a distributed antenna system receives an OFDM signal transmitted in a time division multiplexing mode. The communication apparatus converts the OFDM signal into a baseband time-domain waveform signal, calculates a correlation value from a part of the time-domain waveform signal, performs FFT on the time-domain waveform signal, calculates a degree of similarity from a part of a frequency-domain waveform signal resulting from the FFT, estimates a switchover timing between uplink communication and downlink communication based on the degree of similarity, calculates a power of a part of the frequency-domain waveform signal, and displays a result of the power calculation.

### CROSS-REFERENCE TO RELATED APPLICATION

This application is a Continuation Application of PCT Application No. PCT/JP 2024/038744, filed Oct. 30, 2024 and based upon and claiming the benefit of priority from Japanese Patent Application No. 2023-187872, filed Nov. 1, 2023, the entire contents of all of which are incorporated herein by reference.

### FIELD

Embodiments described herein relate generally to a communication apparatus, and a control method.

### BACKGROUND

As a solution for indoor coverage of a mobile communication system, a distributed antenna system (DAS) is known. The distributed antenna system relays signals between a mobile station and a base station, and is constituted by a main unit and multiple distributed subunits. The main unit distributes signals from a single base station to the multiple subunits, and the subunits output the same downlink signal from their respective antennas so as to form an area as a single cell.

In the conventional distributed antenna system, a main unit converts an RF signal into a digital signal and directly transmits the digital signal to the subunits, where the digital signal is converted back into the analog signal. As such, there has been no need for the system to be equipped with a function of decoding control signals, etc. However, TDD repeaters compatible with 5G now have a function of decoding control signals in order to detect a TDD switching timing.

### BRIEF DESCRIPTION OF THE DRAWINGS

FIG. 1 is a schematic diagram showing an exemplary configuration of a distributed antenna system according to an embodiment.

FIG. 2 is a diagram showing an exemplary data configuration of a radio frame.

FIG. 3 is a diagram showing an exemplary SSB arrangement pattern in a radio frame.

FIG. 4 is a diagram showing an exemplary DL/UL configuration and an exemplary SSB arrangement in a TDD mode.

FIG. 5 is a diagram showing an exemplary functional configuration of a main station apparatus according to the embodiment.

FIG. 6 is a diagram showing an exemplary functional configuration of a control unit according to the embodiment.

FIG. 7 is a diagram showing an exemplary functional configuration of a switchover timing generation unit according to the embodiment.

FIG. 8 is a diagram showing an exemplary functional configuration of a PSS detection unit according to the embodiment.

FIG. 9 is a diagram showing an exemplary functional configuration of an SSS detection unit according to the embodiment.

FIG. 10 is a diagram showing an exemplary functional configuration of a DMRS detection unit according to the embodiment.

FIG. 11 is a diagram showing an exemplary functional configuration of a synchronization signal power calculation unit according to the embodiment.

FIG. 12 is a diagram showing an exemplary screen displayed by a power display unit according to the embodiment.

FIG. 13 is a flowchart showing an example of a synchronization signal power calculation process and a power display process according to the embodiment.

FIG. 14 is a diagram showing another exemplary functional configuration of the synchronization signal power calculation unit according to the embodiment.

FIG. 15 is a diagram showing yet another exemplary functional configuration of the synchronization signal power calculation unit according to the embodiment.

### DETAILED DESCRIPTION

According to one embodiment, a communication apparatus in a distributed antenna system receives an OFDM signal transmitted in a time division multiplexing mode. The communication apparatus converts the OFDM signal into a baseband time-domain waveform signal, calculates a correlation value from a part of the time-domain waveform signal, performs FFT on the time-domain waveform signal, calculates a degree of similarity from a part of a frequency-domain waveform signal resulting from the FFT, estimates a switchover timing between uplink communication and downlink communication based on the degree of similarity, calculates a power of a part of the frequency-domain waveform signal, and displays a result of the power calculation.

A communication apparatus, a control method, and a program according to embodiments will be described in detail with reference to the accompanying drawings. Note that, in the following description of each embodiment and modification, components or elements denoted by the same reference symbols are assumed to have substantially the same functions, and redundant explanations will be omitted as appropriate.

### First Embodiment

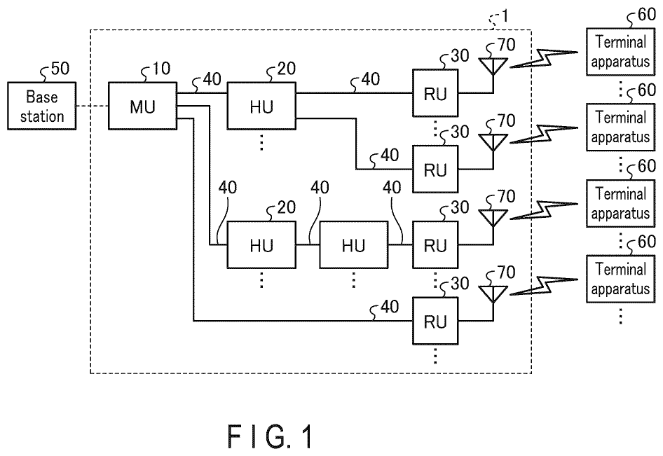

FIG. 1 is a schematic diagram showing one example of an overview of a distributed antenna system 1 according to a first embodiment. The distributed antenna system 1 includes a main station apparatus 10 (MU), a relay apparatus 20 (HU), a substation apparatus 30 (RU), and transmission paths 40 for their connection. More specifically, the distributed antenna system 1 includes a main station apparatus 10 connected to a base station 50, and one or more substation apparatuses 30 for relaying signals between the main station apparatus 10 and terminal apparatuses 60 communicating with the base station 50.

The main station apparatus 10 is connected to multiple substation apparatuses 30 within the distributed antenna system 1. As shown in FIG. 1, the plurality of substation apparatuses 30 may be connected to the main station apparatus 10 via the relay apparatuses 20, or may be directly connected to the main station apparatus 10. Also, as shown in FIG. 1, the relay apparatuses 20 may be connected in cascade to the main station apparatus 10.

The main station apparatus 10 is connected to the base station 50 by a coaxial cable, and communicates radio signals with the base station 50. The radio signals here refer to signals in a radio communication band for transmission to the terminal apparatuses 60. The main station apparatus 10 relays a radio signal received from the base station 50 to the relay apparatuses 20 or the substation apparatuses 30. Also, the main station apparatus 10 relays a radio signal received from the relay apparatuses 20 or the substation apparatuses 30 to the base station 50.

Each substation apparatus 30 is connected to an antenna 70 for wireless communication with the terminal apparatus 60 by a wired cable, and communicates a radio signal with the terminal apparatus 60 via the antenna 70. The substation apparatus 30 relays a radio signal received from the terminal apparatus 60 to the main station apparatus 10 or the relay apparatus 20. The substation apparatus 30 relays a radio signal received from the main station apparatus 10 or the relay apparatus 20 to the terminal apparatus 60.

The distributed antenna system 1 having such a configuration allows for the connection between the base station 50 and wireless terminals that are present at a location where radio waves are not directly reachable, and can realize an enlarged communicable range of a mobile communication network covered by the base station 50. For example, the distributed antenna system 1 is applicable to the mobile communication network such as the 5G.

In the distributed antenna system 1 including the main station apparatus 10, which is connected to the base station 50, and one or more substation apparatuses 30, which are for relaying signals between the main station apparatus 10 and the terminal apparatuses 60 communicating with the base station 50, the main station apparatus 10 is a communication apparatus that may function as either the main station apparatus 10 or the substation apparatus 30 and receives an orthogonal frequency division multiplexing (OFDM) signal transmitted in a time division multiplexing mode. Also, the main station apparatus 10 receives a radio frame including a synchronization signal block (SSB:SS/PBCH Block) in the distributed antenna system 1 according to a TDD mode in which a DL communication and a UL communication switch to each other every predetermined period. An SSB includes a primary synchronization signal (PSS), a secondary synchronization signal (SSS), and a physical broadcast channel (PBCH). The main station apparatus 10 detects and decodes the SSB from the received radio frame, so as to comprehend at which position in the radio frame the received SSB was disposed.

The main station apparatus 10 then estimates the DL/UL switchover timing based on the position of the SSB in the radio frame and a DL/UL pattern in the TDD mode. Accordingly, the main station apparatus 10 can estimate the DL/UL switchover timing even in the case where no power (signal) is present in the head symbol of a radio frame such as the radio signal of the 5G.

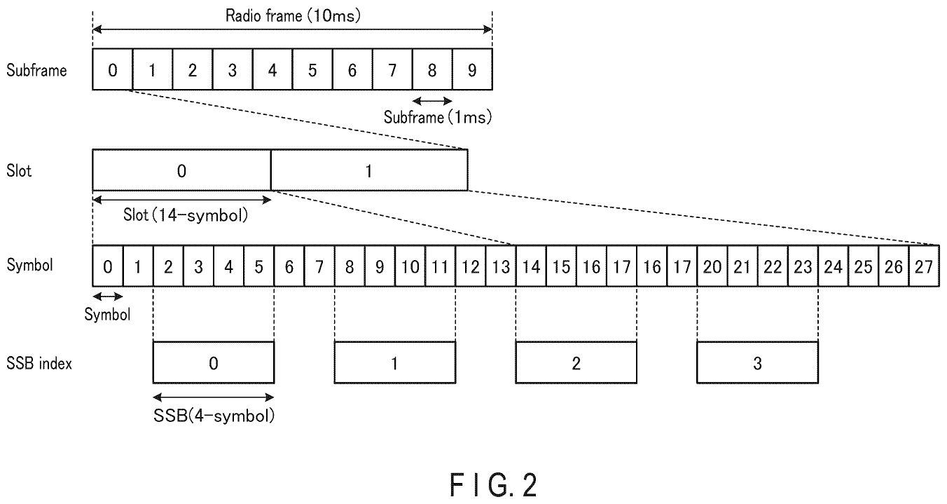

FIG. 2 is a diagram showing an exemplary data configuration of a radio frame. FIG. 2 is one example of a 5G radio frame. One frame is transmitted in 10 ms. Also, one frame is constituted by 10 subframes each transmitted in 1 ms. Here, 5G is compatible with multiple subcarrier frequency intervals, and differences between such intervals create differences in the length of one symbol. As such, the concept of a slot is adopted for radio frames, and a mechanism is employed where the radio frame is divided into slots having multiple symbol numbers for one subframe and a difference in one symbol length due to the difference in subcarrier frequency interval is canceled out by the number of slots per subframe. One slot has 14 symbols regardless of the subcarrier frequency intervals. FIG. 2 illustrates a case where the subcarrier frequency interval is 30 kHz, with one subframe having two slots and constituted by 28 symbols. As shown in FIG. 2, the SSB is arranged at specific positions in the radio frame.

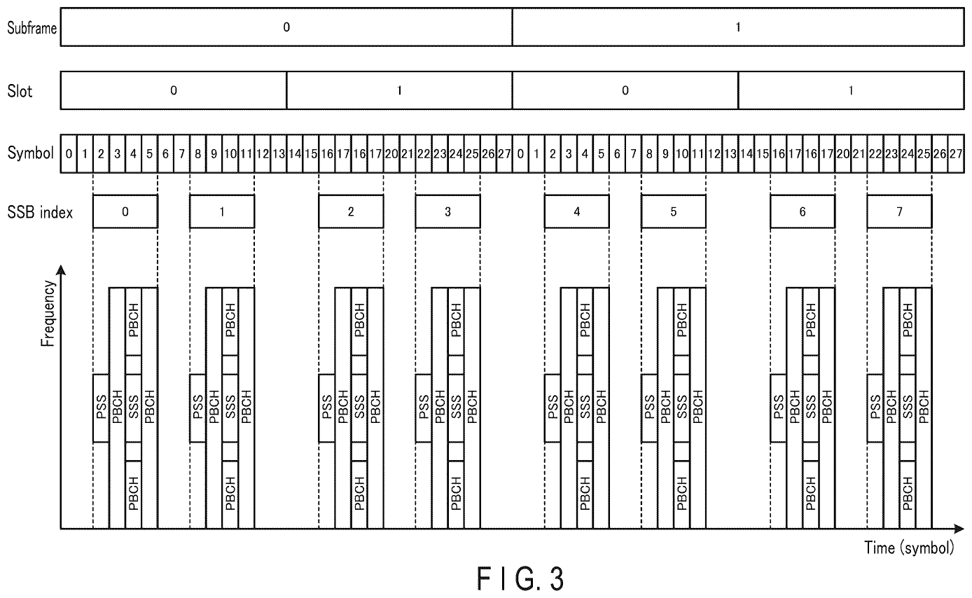

FIG. 3 is a diagram showing an exemplary SSB arrangement pattern in a radio frame. An SSB is constituted by four symbols. Also, an SSB includes two synchronization signals, namely, a PSS and an SSS, and a PBCH signal. The PBCH signal includes a reference signal for decoding the PBCH signal, namely, a DMRS (DeModulation of Reference Signal) for the PBCH signal. SSB index numbers are assigned to the positions of the respective SSBs within the radio frame. As one example, for operations in Japan, values from 0 to 7 are assigned as shown in FIG. 2. Since where to arrange the SSBs depends on service providers, it is necessary to identify, after detecting an SSB, at which position the SSB is arranged.

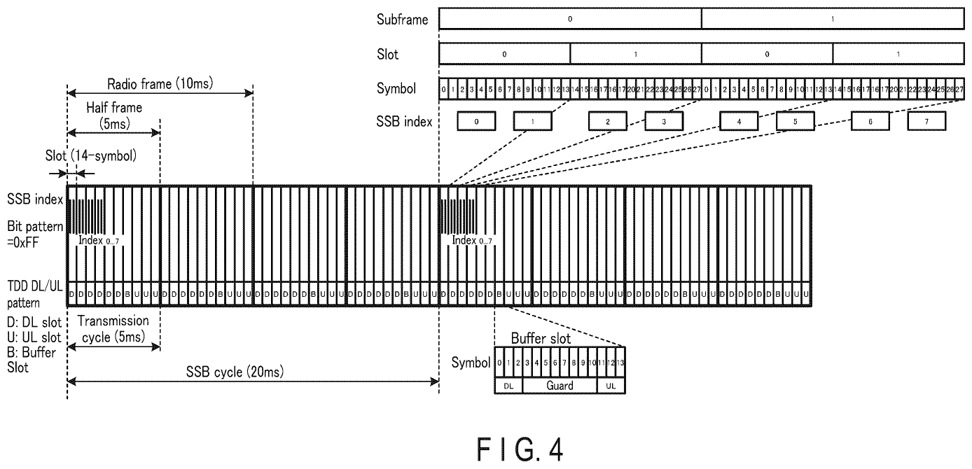

FIG. 4 is a diagram showing an exemplary DL/UL configuration and an exemplary SSB arrangement in a TDD mode. The SSBs illustrated in FIG. 4 represent a case with a subcarrier frequency interval of 30 kHz, an SSB cycle of 20 ms, and a transmission cycle of 5 ms. The transmission cycle includes 10 slots, in which DL is allocated to the first 6 slots, UL is allocated to the last 3 slots, and a buffer slot is provided between the DL slots and the UL slots. In this way, the number of consecutive DL slots and the number of consecutive UL slots in the transmission cycle are set in advance. In the buffer slot, too, consecutive DL symbols, consecutive UL symbols, and blank symbols functioning as a guard therebetween are allocated. Note that the SSB illustrated in FIG. 4 represents a configuration in which three symbols are allocated as each of the DL symbol set and the UL symbol set, and eight symbols are allocated as a guard.

With the above configuration, the main station apparatus 10 can estimate, once the index number of an SSB arranged at a specific position in a radio frame is detected, at which position in the transmission cycle the SSB is arranged. Further, the main station apparatus 10 can estimate, if the DL/UL configuration information of the TDD mode is known, a DL/UL switchover timing within the transmission cycle, from the correlation based on the SSB arrangement positions.

The following description will assume that the direction of communication from the base station 50 to the terminal apparatuses 60 is a downward direction (downlink), and the opposite direction is an upward direction (uplink). In accordance with this, it will be assumed that a signal transmitted in the downward direction is a “DL signal”, and a signal transmitted in the upward direction is a “UL signal”.

Moreover, a downward signal transmitted in the form of a frame will be called a “downlink frame”, and an upward signal transmitted in the form of a frame will be called an “uplink frame”. The description may also refer to the uplink side of a given apparatus as “upper” and a downlink side of the same as “lower”. In accordance with this, the description may refer to an apparatus connected to the upper side of a given apparatus as an “upper apparatus” and an apparatus connected to the lower side as a “lower apparatus”.

As one example, the main station apparatus 10 is an upper apparatus to the relay apparatus 20 and the substation apparatus 30, and the relay apparatus 20 is an upper apparatus to the substation apparatus 30. By contrast, the relay apparatus 20 and the substation apparatus 30 are lower apparatuses to the main station apparatus 10, and the substation apparatus 30 is a lower apparatus to the main station apparatus 10 and the relay apparatus 20.

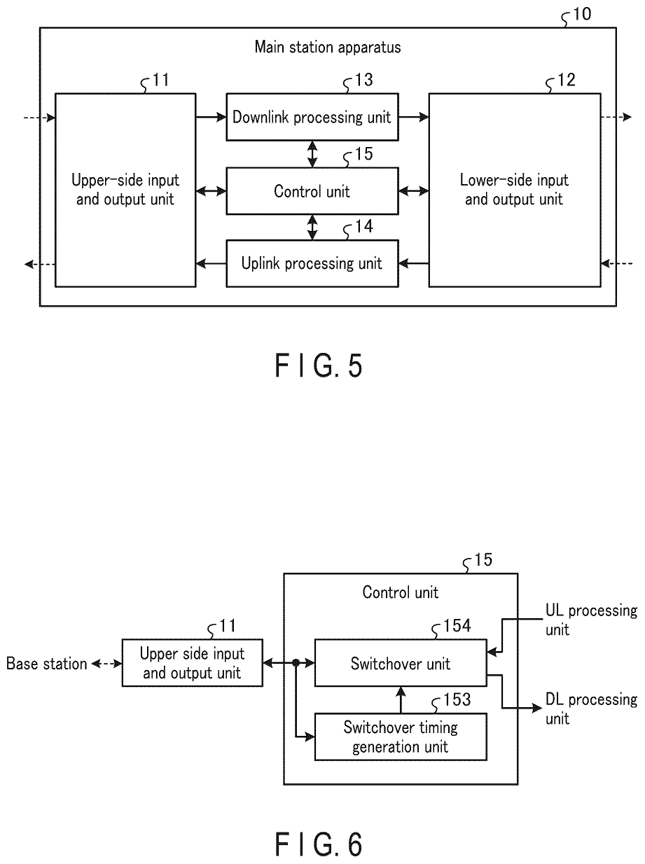

FIG. 5 is a diagram showing an exemplary functional configuration of the main station apparatus 10 according to the first embodiment. The main station apparatus 10 includes a central processing unit (CPU), a memory, an auxiliary storage device, etc., connected together by a bus and executing a program. Through execution of a program or programs, the main station apparatus 10 is equipped with an upper-side input and output unit 11, a lower-side input and output unit 12, a downlink processing unit 13, an uplink processing unit 14, and a control unit 15. All or some of the functions of the main station apparatus 10 may be realized using hardware such as an application specific integrated circuit (ASIC), a programmable logic device (PLD), or a field programmable gate array (FPGA). The programs may be recorded in a computer-readable recording medium. A computer-readable recording medium refers to, for example, a portable medium such as a flexible disk, a magneto-optical disk, a ROM, or a CD-ROM, or a storage device such as a hard disk built within the computer system. The programs may be transmitted via electric communication lines.

The upper-side input and output unit 11 is a communication interface for inputting and outputting radio signals between an upper apparatus and the main station apparatus 10. More specifically, the upper-side input and output unit 11 is a communication interface for inputting and outputting radio signals with the base station 50 via a coaxial cable. The upper-side input and output unit 11 outputs a DL signal received from the base station 50 to the downlink processing unit 13, and outputs a UL signal input from the uplink processing unit 14 to the base station 50.

The lower-side input and output unit 12 is a communication interface for inputting and outputting radio signals between a lower apparatus and the main station apparatus 10. More specifically, the lower-side input and output unit 12 is a communication interface for inputting and outputting radio signals with the substation apparatus 30. The lower-side input and output unit 12 outputs a UL signal received from the substation apparatus 30 to the uplink processing unit 14, and outputs a DL signal input from the downlink processing unit 13 to the substation apparatus 30.

The downlink processing unit 13 performs a process for outputting, to the lower apparatus, the DL signal received by the main station apparatus 10 from the upper apparatus (the process will be called a “DL process”). More specifically, the DL process of the main station apparatus 10 includes subjecting the DL signal received from the base station 50 to analog-to-digital (AD) conversion processing, performing mapping processing for associating the digital signal with a frame, etc. The downlink processing unit 13 outputs the downlink frame that has been associated with the DL signal by the DL process to the lower-side input and output unit 12.

The uplink processing unit 14 performs a process for outputting, to the upper apparatus, the UL signal received by the main station apparatus 10 from the lower apparatus (the process will be called a “UL process”). More specifically, the UL process of the main station apparatus 10 includes performing demapping processing for acquiring a UL signal from the uplink frame received from the relay apparatus 20 or the substation apparatus 30, subjecting the UL signal acquired by the demapping processing to digital-to-analog (DA) conversion processing, etc. The uplink processing unit 14 outputs the UL signal that has been converted into an analog signal by the UL process to the upper-side input and output unit 11.

The control unit 15 has a function of switching the main station apparatus 10 between uplink communication and downlink communication. More specifically, the control unit 15 has a function of detecting a switchover between uplink communication and downlink communication, and switches between the DL process and the UL process (transmission operations) at the timing of detecting the switchover between the uplink communication and the downlink communication.

FIG. 6 is a diagram showing an exemplary functional configuration of the control unit 15 according to the first embodiment. The control unit 15 includes a switchover timing generation unit 153 and a switchover unit 154.

The switchover timing generation unit 153 estimates the UL period or the DL period and gives a notification about the timing of switching between the UL process and the DL process. More specifically, the switchover timing generation unit 153 gives a notification about the start timing of the estimated UL period or DL period. As the start timing, the notification may indicate a start time of the UL period or the DL period, or an elapsed time from the current time. The notification of the start timing may indicate the arrival of the start timing.

The switchover unit 154 switches between the UL process and the DL process at the switching timing notified from the switchover timing generation unit 153.

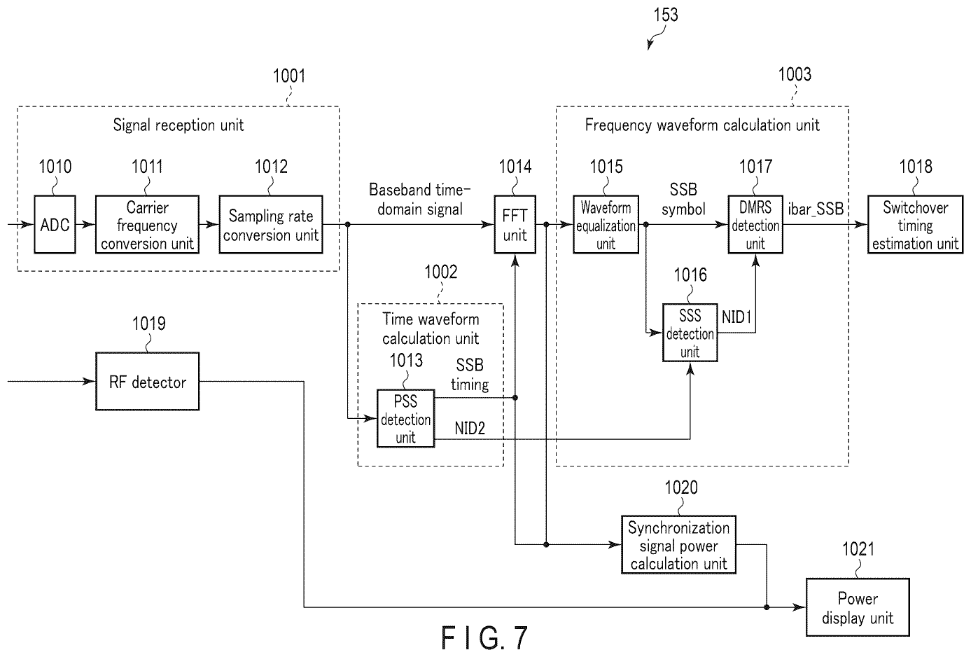

FIG. 7 is a diagram showing an exemplary functional configuration of the switchover timing generation unit 153 according to the first embodiment. The switchover timing generation unit 153 includes a signal reception unit 1001, a time waveform calculation unit 1002, a fast Fourier transform (FFT) unit 1014, a frequency waveform calculation unit 1003, a switchover timing estimation unit 1018, an RF detector 1019, a synchronization signal power calculation unit 1020, and a power display unit 1021. Note that the RF detector 1019, the synchronization signal power calculation unit 1020, and the power display unit 1021 are not required to be included in the switchover timing generation unit 153, and they can serve the purpose as long as they are included in at least the control unit 15 or the main station apparatus 10.

The signal reception unit 1001 includes an ADC unit 1010, a carrier frequency conversion unit 1011, and a sampling rate conversion unit 1012. The signal reception unit 1001 receives an OFDM signal and converts it into a baseband time-domain waveform signal. More specifically, the signal reception unit 1001 receives a radio frame including an SSB. That is, the signal reception unit 1001 receives an SSB which includes a PSS, an SSS, and a PBCH including a DMRS.

The ADC unit 1010 converts the input analog signal into a digital signal and outputs the digital signal to the carrier frequency conversion unit 1011. The carrier frequency conversion unit 1011 converts the input digital signal into a baseband signal by subjecting the digital signal to frequency down-conversion, and outputs the baseband signal to the sampling rate conversion unit 1012. The sampling rate conversion unit 1012 converts the sampling rate of the input baseband signal to generate a baseband time-domain waveform signal, which is a time-domain waveform signal of the baseband. The sampling rate conversion unit 1012 then outputs the baseband time-domain waveform signal to a PSS detection unit 1013 and the FFT unit 1014.

The time waveform calculation unit 1002 includes the PSS detection unit 1013. The time waveform calculation unit 1002 extracts a portion of the baseband time-domain waveform signal output from the signal reception unit 1001, and calculates a correlation value between the extracted signal and a known signal.

The PSS detection unit 1013 detects a PSS signal included in the time-domain waveform signal. More specifically, the PSS detection unit 1013 detects, from the baseband signal that has undergone the sampling rate conversion, a PSS signal arranged at the head of the SSB, and outputs the timing of detection to the FFT unit 1014 as an SSB timing. Also, the PSS detection unit 1013 determines which PSS code sequence among multiple PSS code sequences the detected PSS signal corresponds to, and outputs the determination result to an SSS detection unit 1016 as an NID2, i.e., the cell identity of a physical layer.

The FFT unit 1014 performs FFT on the time-domain waveform signal output from the signal reception unit 1001. More specifically, the FFT unit 1014 takes out, based on the input SSB timing, the SSB from the baseband time-domain waveform signal that has undergone the sampling rate conversion, and performs Fourier transform. The FFT unit 1014 then outputs a frequency-domain waveform signal of the SSB obtained by the Fourier transform to a waveform equalization unit 1015 and the synchronization signal power calculation unit 1020.

The frequency waveform calculation unit 1003 includes the waveform equalization unit 1015, the SSS detection unit 1016, and a DMRS detection unit 1017. The frequency waveform calculation unit 1003 extracts a portion of the frequency-domain waveform signal output from the FFT unit 1014, and calculates the degree of similarity between the extracted signal and a known signal.

The waveform equalization unit 1015 performs correction of at least one of an amplitude distortion or a phase distortion on the IQ complex plane for the frequency-domain waveform signal. More specifically, the waveform equalization unit 1015 performs correction of at least one of an amplitude distortion or a phase distortion on the IQ complex plane for the input frequency-domain waveform signal of the SSB, and outputs a corrected SSB symbol to the SSS detection unit 1016 and the DMRS detection unit 1017.

The SSS detection unit 1016 detects an SSS signal included in the frequency-domain waveform signal. More specifically, the SSS detection unit 1016 detects an SSS signal from the frequency-domain waveform signal of the SSB that has undergone the waveform equalization by the waveform equalization unit 1015. Also, the SSS detection unit 1016 determines which SSS sequence among multiple SSS sequences the detected SSS signal corresponds to. The SSS detection unit 1016 then outputs the determination result to the DMRS detection unit 1017 as an NID1 indicative of a cell identity group of the determined physical layer.

The DMRS detection unit 1017 detects a DMRS signal included in the frequency-domain waveform signal. More specifically, the DMRS detection unit 1017 detects a DMRS signal from the frequency-domain waveform signal of the SSB that has undergone the waveform equalization. The DMRS detection unit 1017 determines which DMRS sequence among multiple DMRS sequences the detected DMRS signal corresponds to. The DMRS detection unit 1017 then outputs an ibar_SSB that corresponds to the DMRS sequence to the switchover timing estimation unit 1018.

The switchover timing estimation unit 1018 estimates a switchover timing between the uplink communication and the downlink communication for its own apparatus based on the calculation result by the frequency waveform calculation unit 1003. More specifically, the switchover timing estimation unit 1018 estimates, from the input ibar_SSB, at which position in the transmission cycle the SSB is arranged. The switchover timing estimation unit 1018 estimates the DL/UL switchover timing within the transmission cycle from the arrangement position of the estimation target SSB and the DL/UL configuration information in the known TDD mode.

The RF (radio frequency) detector 1019 measures various indexes for the radio signal input from the upper-side input and output unit 11. For example, the RF detector 1019 outputs a DC voltage that is proportional to the logarithm by conversion from an input radio signal power. The RF detector 1019 outputs the power measurement (hereinafter referred to as “RF detector power”) to the power display unit 1021.

The synchronization signal power calculation unit 1020 extracts a portion of the frequency-domain waveform signal output from the FFT unit 1014, and calculates a power of the extracted frequency-domain waveform signal. A number of definitions are available for the signal power in a synchronization signal (SSB), but in the case of the SSB arrangement pattern in the radio frame shown in FIG. 3 as one example, the synchronization signal power calculation unit 1020 extracts the signal of a defined resource element (RE) from the defined synchronization signal in FIG. 3 and calculates only the power of the extracted portion. The synchronization signal power calculation unit 1020 outputs the calculated power value (hereinafter referred to as “synchronization signal power”) to the power display unit 1021.

The power display unit 1021 acquires the RF detector power output from the RF detector 1019 and the synchronization signal power output from the synchronization signal power calculation unit 1020. The power display unit 1021 controls an external output apparatus to display the calculation results. In an example, the external output apparatus is a monitor, a mobile terminal, or the like. Note that the power display unit 1021 itself may be an output apparatus such as a monitor, and in such cases, the power display unit 1021 displays the acquired calculation results.

The power display unit 1021 switches between display and non-display of the synchronization signal power according to the synchronization status of the switchover timing estimation unit 1018. For example, in the case where the synchronization status of the switchover timing estimation unit 1018 indicates an unsynchronized state, the power display unit 1021 causes the external output apparatus not to display a value of the synchronization signal power. Once the synchronization status of the switchover timing estimation unit 1018 turns to a synchronized state, the power display unit 1021 performs control so that the synchronization signal power value is switched from the non-display to the display. Details of the screen display for the synchronization signal power will be set forth later.

The power display unit 1021 switches between display and non-display of a level determination result according to the synchronization status of the switchover timing estimation unit 1018. For example, in the case where the synchronization status of the switchover timing estimation unit 1018 indicates the unsynchronized state, the power display unit 1021 causes the external output apparatus not to display the level determination result. Once the synchronization status of the switchover timing estimation unit 1018 turns to the synchronized state, the power display unit 1021 performs control so that the level determination result is switched from the non-display to the display. Details of the screen display for the level determination result will be set forth later.

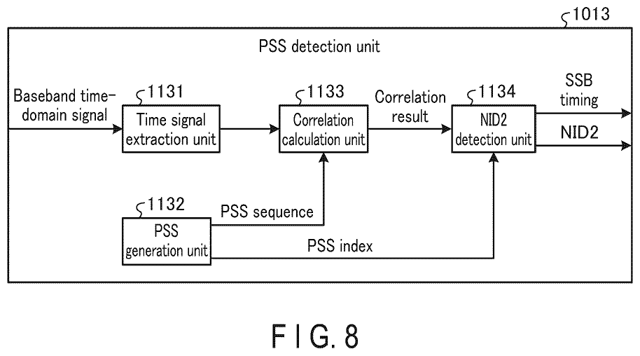

FIG. 8 is a diagram showing an exemplary functional configuration of the PSS detection unit 1013 according to the first embodiment. The PSS detection unit 1013 includes a time signal extraction unit 1131, a PSS generation unit 1132, a correlation calculation unit 1133, and an NID2 detection unit 1134.

The time signal extraction unit 1131 extracts a portion of a time-domain waveform signal. More specifically, the time signal extraction unit 1131 extracts data having a length of the OFDM symbol period from an input baseband time-domain waveform signal, and outputs the extracted data to the correlation calculation unit 1133. That is, the time signal extraction unit 1131 outputs a portion of the baseband time-domain waveform signal to the correlation calculation unit 1133.

The PSS generation unit 1132 outputs multiple PSS code sequences of the PSS signal and also code sequence numbers for identifying the PSS code sequences. More specifically, the PSS generation unit 1132 outputs, as a PSS sequence, multiple PSS code sequences to the correlation calculation unit 1133. The PSS generation unit 1132 also outputs a PSS index, which is a code sequence number for identifying the PSS code sequence, to the NID2 detection unit 1134.

The correlation calculation unit 1133 performs a correlation calculation between the time-domain waveform signal output from the time signal extraction unit 1131 and the PSS sequence as the PSS code sequences from the PSS generation unit 1132, and outputs a correlation value. The correlation calculation unit 1133 is an example of a first correlation calculation unit. That is, the correlation calculation unit 1133 performs a correlation calculation between the baseband time-domain waveform signal input from the time signal extraction unit 1131 and the PSS sequence, and outputs the calculation result correlation value to the NID2 detection unit 1134.

The NID2 detection unit 1134 outputs, as an SSB timing, the timing at which the correlation value calculated by the correlation calculation unit 1133 becomes the highest for a predetermined time range, and also outputs, as an NID2 which is the cell identity of a physical layer, the PSS sequence for the PSS code sequence number corresponding to the PSS code sequence with the highest correlation value. More specifically, the NID2 detection unit 1134 outputs, as an SSB timing, the timing at which the correlation value of the inputs is the highest for a predetermined time range. Also, the NID2 detection unit 1134 outputs, as an NID2 which is the cell identity of a physical layer, the PSS index corresponding to the PSS sequence with the highest correlation value.

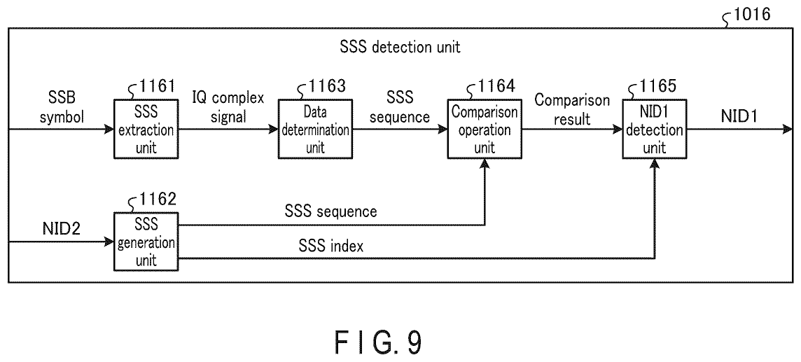

FIG. 9 is a diagram showing an exemplary functional configuration of the SSS detection unit 1016 according to the first embodiment. The SSS detection unit 1016 includes an SSS extraction unit 1161, an SSS generation unit 1162, a data determination unit 1163, a comparison operation unit 1164, and an NID1 detection unit 1165.

The SSS extraction unit 1161 extracts, from the frequency-domain waveform signal, a frequency component where an SSS signal is arranged. More specifically, the SSS extraction unit 1161 extracts, from the SSB symbols which are the input frequency-domain waveform signal that has undergone the waveform equalization correction, a frequency component in which an SSS signal is arranged, and outputs the extracted frequency component to the data determination unit 1163. That is, the SSS extraction unit 1161 outputs the frequency component of the SSS signal.

The SSS generation unit 1162 outputs multiple SSS sequences corresponding to the NID2 which is the cell identity of a physical layer and which is the output of the PSS detection unit 1013, and also outputs an SSS index for identifying the SSS sequence. More specifically, the SSS generation unit 1162 generates multiple SSS code sequences based on the input NID2, and outputs the SSS code sequences to the comparison operation unit 1164 as an SSS sequence. The SSS generation unit 1162 also outputs an SSS index for identifying the SSS sequence to the NID1 detection unit 1165.

The data determination unit 1163 determines demodulation data corresponding to an IQ complex coordinate position of the SSS signal output from the SSS extraction unit 1161, and outputs a series of data determined for the entire SSS signal to the comparison operation unit 1164 as an SSS sequence. The data determination unit 1163 is an example of a first data determination unit.

The comparison operation unit 1164 compares the SSS sequence from the data determination unit 1163 with the SSS sequence from the SSS generation unit 1162, and outputs the match number representing the agreement of values to the NID1 detection unit 1165 as a comparison result. The comparison operation unit 1164 is an example of a first comparison operation unit. Note that the comparison operation unit 1164 may output, to the NID1 detection unit 1165, a similarity degree indicating a degree of similarity between the SSS sequence from the data determination unit 1163 and the SSS sequence from the SSS generation unit 1162.

The NID1 detection unit 1165 determines the comparison result having the highest match number from among the comparison results output from the comparison operation unit 1164. The NID1 detection unit 1165 then outputs the SSS index corresponding to the SSS sequence with the highest match number as the NID1 indicating the cell identity group of the physical layer. The NID1 detection unit 1165 is an example of a first NID1 detection unit.

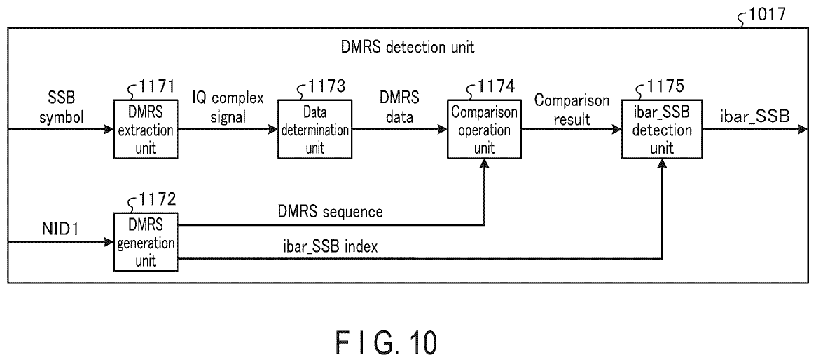

FIG. 10 is a diagram showing an exemplary functional configuration of the DMRS detection unit 1017 according to the first embodiment. The DMRS detection unit 1017 includes a DMRS extraction unit 1171, a DMRS generation unit 1172, a data determination unit 1173, a comparison operation unit 1174, and an ibar_SSB detection unit 1175.

The DMRS extraction unit 1171 extracts, from the frequency-domain waveform signal, a frequency component where a DMRS signal is arranged. More specifically, the DMRS extraction unit 1171 extracts, from the SSB symbols which are the input frequency-domain waveform signal that has undergone the waveform equalization correction, a frequency component in which a DMRS signal is arranged, and outputs the extracted frequency component to the data determination unit 1173. That is, the DMRS extraction unit 1171 outputs the frequency component of the DMRS signal.

The DMRS generation unit 1172 outputs multiple DMRS sequences corresponding to the NID1 which indicates the cell identity group of the physical layer and which is the output of the SSS detection unit 1016, and also outputs an ibar_SSB index for identifying the DMRS sequence. More specifically, the DMRS generation unit 1172 generates multiple code sequences based on the input NID1, and outputs the code sequences to the comparison operation unit 1174 as a DMRS sequence. The DMRS generation unit 1172 also outputs a DMRS index for identifying the DMRS sequence to the ibar_SSB detection unit 1175.

The data determination unit 1173 determines demodulation data corresponding to an IQ complex coordinate position of the DMRS signal output from the DMRS extraction unit 1171, and outputs a series of data determined for the entire DMRS signal to the comparison operation unit 1174 as a DMRS sequence. The data determination unit 1173 is an example of a second data determination unit.

The comparison operation unit 1174 compares the DMRS sequence from the data determination unit 1173 with the DMRS sequence from the DMRS generation unit 1172, and outputs the match number representing the agreement of values to the ibar_SSB detection unit 1175 as a comparison result. The comparison operation unit 1174 is an example of a third comparison operation unit.

The ibar_SSB detection unit 1175 determines the comparison result having the highest match number from among the comparison results output from the comparison operation unit 1174. The ibar_SSB detection unit 1175 then outputs the ibar_SSB index corresponding to the DMRS sequence with the highest match number as the ibar_SSB. The ibar_SSB detection unit 1175 is an example of a first ibar_SSB detection unit.

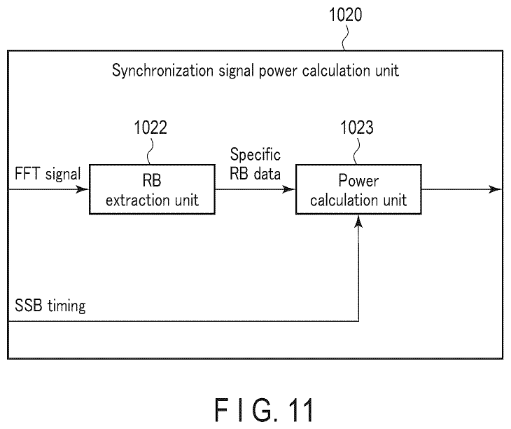

FIG. 11 is a diagram showing an exemplary functional configuration of the synchronization signal power calculation unit 1020 according to the first embodiment. The synchronization signal power calculation unit 1020 includes an RB extraction unit 1022 and a power calculation unit 1023.

The RB extraction unit 1022 acquires the frequency-domain waveform signal output from the FFT unit 1014. The RB extraction unit 1022 extracts specific resource block (RB) data from the acquired frequency-domain waveform based on a defined resource element. The RB extraction unit 1022 outputs the extracted specific resource block data to the power calculation unit 1023.

The power calculation unit 1023 acquires the specific resource block data output from the RB extraction unit 1022. The power calculation unit 1023 determines, from the SSB timing (the arrangement position of the SSB in the transmission cycle), a timing of the resource element for which the power should be calculated. The power calculation unit 1023 calculates the synchronization signal power from the specific resource block data and the determined timing of the resource element. The power calculation unit 1023 outputs the calculated synchronization signal power to the power display unit 1021.

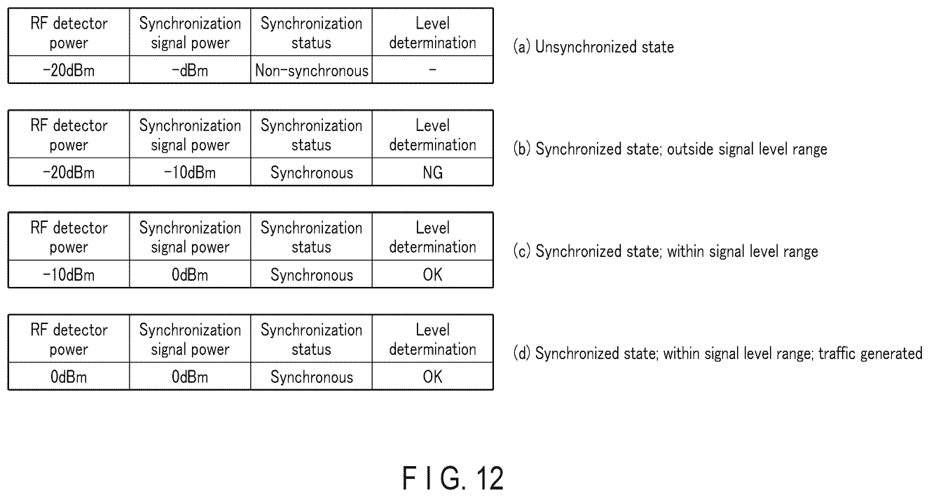

Next, a number of examples of the display screen for display through the power display unit 1021 will be described. FIG. 12 is a diagram showing an exemplary screen displayed by the power display unit 1021 according to the first embodiment.

In one example, the power display unit 1021 displays an RF detector power, a synchronization signal power, a synchronization status, and a level determination as shown in FIG. 12. The information displayed by the power display unit 1021 is not limited to what is shown in FIG. 12, but any information required by the user, etc. may be preset to be displayed.

FIG. 12(a) represents a state immediately after the emission of a radio wave from the base station 50 and before the synchronization. In the case of the state before the synchronization, the power display unit 1021 performs, for example, control to display the RF detector power as “−20 dB” and the synchronous status as “non-synchronous”, and not to display the synchronization signal power or the level determination result.

FIG. 12(b) represents a synchronized and outside-signal-level-range state. For example, once the synchronization status transitions from the unsynchronized state shown in FIG. 12(a) to a synchronized state, the synchronization signal power and the level determination result are enabled to be displayed. For the case shown in FIG. 12(b), a proper level is assumed to be from +3 dB to −3 dB, and accordingly, the level determination result is displayed as “NG”.

FIG. 12(c) represents a synchronized and within-signal-level-range state. For example, FIG. 12(c) is a result of adjusting the input level from the base station 50, and accordingly, the synchronization signal power is within the range of the proper level and the level determination result is displayed as “OK”.

FIG. 12(d) represents a synchronized and within-signal-level-range state but traffic has started to flow from the base station 50. For example, while the RF detector power in FIG. 12(d) is higher than the RF detector power in FIG. 12(c), the synchronization signal power does not differ from the synchronization signal power in FIG. 12(c), and therefore, the synchronization signal power is within the proper level range and the level determination result is displayed as “OK”.

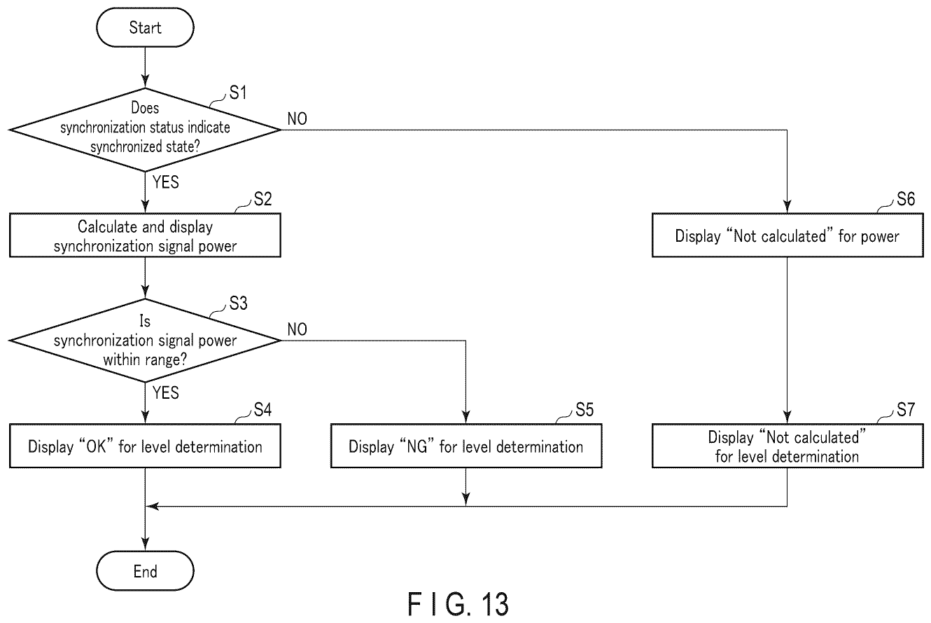

Next, the course of processing for determining the display in FIG. 12 will be described with reference to the flowchart given in FIG. 13. FIG. 13 is a flowchart showing an example of the synchronization signal power calculation process and the power display process according to the first embodiment.

Upon start of the synchronization signal power calculation process and the power display process, the synchronization signal power calculation unit 1020 determines whether or not the synchronization status indicates a synchronized state (step S1). In response to determining that the synchronization status indicates the synchronized state (step S1), the synchronization signal power calculation unit 1020 calculates the synchronization signal power, and the power display unit 1021 performs control to display the calculated synchronization signal power through an external output apparatus or the like (step S2).

Next, the power display unit 1021 determines whether or not the synchronization signal power is within a preset proper level range (step S3). In response to determining that the synchronization signal power is within the proper level range (step S3, YES), the power display unit 1021 causes the external output apparatus or the like to display “OK” as the level determination result (step S4).

When the power display unit 1021 determines that the synchronizing signal power is out of the proper level range (step S3, NO), the power display unit 1021 causes the external output apparatus to display NG as the level determination result (step S5). Note that the character string to be displayed on the screen as the level determination result is not limited to “OK” or “NG”, and any other character string or the like may be used as long as such a string or the like allows visual recognition of the synchronization signal power being within the proper level range or outside the proper level range.

Also, the synchronization signal power calculation unit 1020, in response to determining that the synchronization status does not indicate the synchronized state, that is, the synchronization status indicates an unsynchronized state (step S1), transmits a signal indicating the unsynchronized state to the power display unit 1021, and the power display unit 1021 causes the external output apparatus or the like to display that the synchronization signal power has not been calculated yet or not to display the synchronization signal power (step S6).

The power display unit 1021 also causes the external output apparatus or the like to display that the level determination result has not been calculated yet or not to display the level determination result (step S7). Upon executing the processing of steps S4, S5, and S7, the synchronization signal power calculation process and the power display process are terminated. The synchronization signal power calculation process and the power display process are performed at desired timings and are repeatedly performed.

With the communication apparatus according to the present embodiment, a synchronization signal power is calculated and then the synchronizing signal power and a level determination result are displayed. Therefore, the distributed antenna system for 5GNR is enabled to provide visual recognition of an appropriate main unit input level, which was not possible to determine from the input level from a base station using a measurement by an RF detector, and the capability of adjustment to the appropriate main unit input level can now be realized.

### Second Embodiment

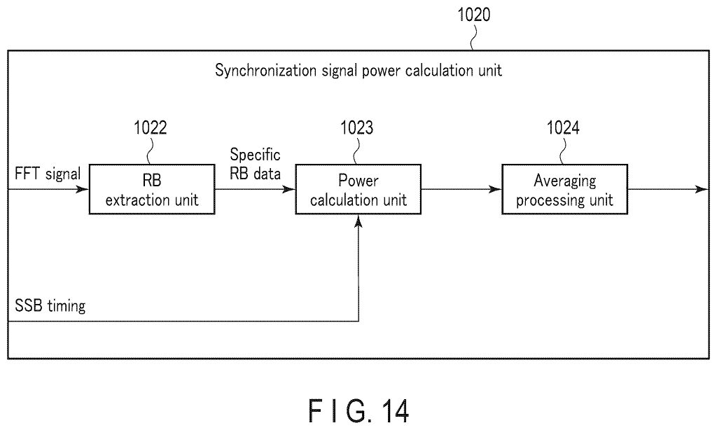

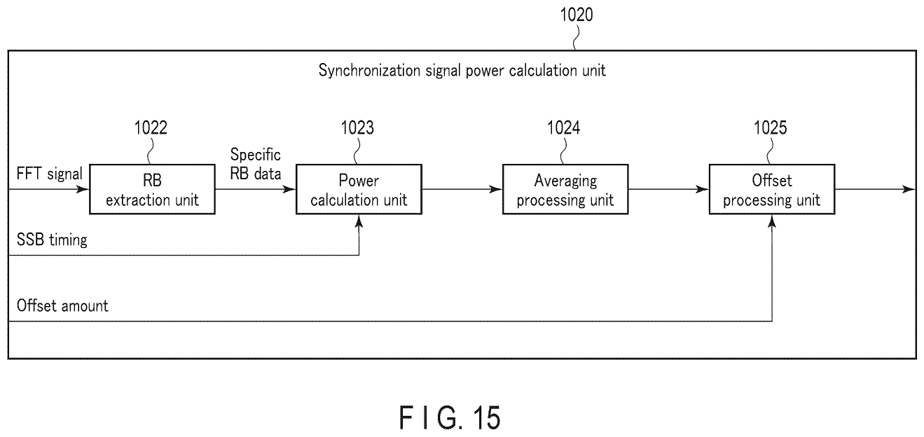

A second embodiment adds a configuration of an averaging processing unit 1024 to the synchronization signal power calculation unit 1020 while keeping the other functional configurations the same as those of the first embodiment; thus, the description of the same functional configurations will be omitted. FIG. 14 is a diagram showing another exemplary functional configuration of the synchronization signal power calculation unit according to the second embodiment.

The averaging processing unit 1024 averages multiple synchronization signal power values output from the power calculation unit 1023, and outputs an average synchronization signal power. For example, supposing that a synchronization signal has a cycle of 20 ms, the averaging processing unit 1024 acquires the synchronization signal power output every 20 ms from the power calculation unit 1023, calculates an average synchronization signal power according to the number of times the synchronization signal power is acquired, and outputs the average synchronization signal power.

With the communication apparatus according to this embodiment, the averaging processing unit calculates an average of multiple synchronization signal power values. Therefore, it is possible to suppress a rapid change in the synchronization signal power, and also to improve the accuracy of the result of calculation by the synchronization signal power calculation unit.

### Third Embodiment

A third embodiment adds a configuration of an offset processing unit 1025 to the synchronization signal power calculation unit 1020 while keeping the other functional configurations the same as those of the first embodiment and the second embodiment; thus, the description of the same functional configurations will be omitted. FIG. 15 is a diagram showing yet another exemplary functional configuration of the synchronization signal power calculation unit according to the third embodiment.

It is known that, for example, even when a signal bandwidth is changed, the bandwidth of a synchronization signal may remain unchanged while an RF detector power is changed. That is, the ratio between the RF detector power and the synchronization signal power can vary according to the signal bandwidth. Here, in the conventional distributed antenna system, adjustment with values of the RF detector power has been performed at the time of full traffic. As such, in order to align the result for the synchronization signal power with the level value of the conventional distributed antenna system, an offset function to cope with the signal bandwidth is necessary.

Accordingly, the offset processing unit 1025 subjects the average synchronization signal power output from the averaging processing unit 1024 to an offset process. The offset processing unit 1025 is adapted so that the offset amount can be changed by an upper apparatus, i.e., a monitoring and controlling terminal. Also, the offset process by the offset processing unit 1025 is assumed to be employed in such instances where the same port is used in different signal bandwidths. With the offset function, it is possible to provide, for a user, etc., who is viewing the synchronization signal power through a monitor, the display of the RF detector power that is equivalent to the RF detector power at the time of full traffic, and accordingly, improved usability can be realized.

Therefore, the communication apparatus, the control method, and the program according to the embodiment allows the user to recognize appropriate power.

While certain embodiments have been described, they have been presented by way of example only, and they are not intended to limit the scope of the inventions. Indeed, the novel embodiments described herein may be worked in a variety of other forms. Furthermore, various omissions, substitutions, and changes in the form of the embodiments may be made without departing from the spirit of the inventions. The embodiments and their modifications are covered by the accompanying claims and their equivalents, as would fall within the scope and the gist of the claimed inventions.

What is claimed is:

1. A communication apparatus in a distributed antenna system, the distributed antenna system comprising a main station apparatus and one or more substation apparatuses, the main station apparatus being connected to a base station, the one or more substation apparatuses being configured to relay a signal between the main station apparatus and a terminal apparatus which communicates with the base station, the communication apparatus being configured to function as the main station apparatus or each of the one or more substation apparatuses and to receive an OFDM signal transmitted in a time division multiplexing mode, the communication apparatus comprising:
a signal reception unit configured to receive and convert the OFDM signal into a baseband time-domain waveform signal;
a time waveform calculation unit configured to extract a portion of the time-domain waveform signal output from the signal reception unit and to calculate a correlation value between the extracted signal and a known signal;
an FFT unit configured to perform FFT on the time-domain waveform signal output from the signal reception unit;
a frequency waveform calculation unit configured to extract a portion of a frequency-domain waveform signal output from the FFT unit and to calculate a degree of similarity between the extracted signal and a known signal;
a switchover timing estimation unit configured to estimate a switchover timing between uplink communication and downlink communication in the communication apparatus based on a calculation result by the frequency waveform calculation unit;
a synchronization signal power calculation unit configured to extract a portion of the frequency-domain waveform signal output from the FFT unit and to calculate a power of the extracted frequency-domain waveform signal; and
a power display unit configured to cause a calculation result by the synchronization signal power calculation unit to be displayed.

2. The communication apparatus according to claim 1, wherein the synchronization signal power calculation unit comprises an averaging processing unit configured to average an output of the synchronization signal power calculation unit.

3. The communication apparatus according to claim 2, wherein the synchronization signal power calculation unit comprises an offset processing unit configured to offset the power output from the synchronization signal power calculation unit.

4. The communication apparatus according to claim 1, wherein the power display unit is configured to switch between display and non-display of the power and a level determination according to a synchronization status of the switchover timing estimation unit.

5. A method for controlling a communication apparatus in a distributed antenna system, the distributed antenna system comprising a main station apparatus and one or more substation apparatuses, the main station apparatus being connected to a base station, the one or more substation apparatuses being configured to relay a signal between the main station apparatus and a terminal apparatus which communicates with the base station, the communication apparatus being configured to function as the main station apparatus or each of the one or more substation apparatuses and to receive an OFDM signal transmitted in a time division multiplexing mode, the method comprising:
receiving and converting the OFDM signal into a baseband time-domain waveform signal;
extracting a portion of the time-domain waveform signal and calculating a correlation value between the extracted signal and a known signal;
performing an FFT on the time-domain waveform signal;
extracting a portion of a frequency-domain waveform signal resulting from the FFT and calculating a degree of similarity between the extracted signal and a known signal;
estimating a switchover timing between uplink communication and downlink communication in the communication apparatus based on a degree of similarity calculation result;
extracting a portion of the frequency-domain waveform signal and calculating a power of the extracted frequency-domain waveform signal; and
causing a power calculation result to be displayed.
